(19) United States
(12) Patent Application Publication
(10) Pub. No.: US 2009/0059466 A1
(43) Pub. Date: Mar. 5, 2009

(54) METAL-INSULATOR-METAL CAPACITOR AND METHOD FOR MANUFACTURING THE SAME

(76) Inventor: Jeong-Ho Park, Icheon-si (KR)

Correspondence Address: SHERR & VAUGHN, PLLC, 620 HERNDON PARKWAY, SUITE 200, HERNDON, VA, 20170, US

(21) Appl. No.: 12/197,272

(22) Filed: Aug. 24, 2008

(30) Foreign Application Priority Data
Aug. 29, 2007 (KR) 10-2007-0087065

(51) Int. Cl. H01G 4/008

(52) U.S. Cl. 361/301.4; 29/25.41

(57) ABSTRACT

A metal-insulator-metal (MIM) capacitor capable of achieving an enhancement in the reliability of a semiconductor device, and a method for manufacturing the same are disclosed. The disclosed MIM capacitor includes a metal-insulator-metal (MIM) capacitor which may include a first insulating film, a first metal layer formed over the first insulating film and a first capacitor insulating film formed over the first metal layer. A second metal layer may be formed over a portion of the first capacitor insulating film and second capacitor insulating film may be formed over the second metal layer. A third metal layer may be formed over a portion of the second capacitor insulating film and a nitride film may be formed over the third metal layer. A multilayer insulating film may be formed over the entire upper surface of the resulting structure. First and second metal lines may be formed in contact holes extending through the first capacitor insulating film, the second capacitor insulating film, and the nitride film after extending through the multilayer insulating film.

The present application claims priority under 35 U.S.C. 119 to Korean Patent Application No. 10-2007-0087065 (filed on Aug. 29, 2007), which is hereby incorporated by reference in its entirety.

### BACKGROUND

Recent high integration techniques for semiconductor devices led to research and development of a semiconductor device in which an analog capacitor is integrated with a logic circuit. Currently, this product is available. In the case of an analog capacitor used in a complementary metal oxide silicon (CMOS) logic, it may take the form of polysilicon-insulator-polysilicon (PIP) or metal-insulator-metal (MIM).

Such a PIP or MIM capacitor needs to be relatively accurately constructed, as compared to an MOS type capacitor or a junction capacitor, because it is independent of bias. In the case of a capacitor having a PIP structure, conductive polysilicon is used for upper and lower electrodes of the capacitor. For this reason, oxidation may occur at an interface between the electrodes and a dielectric thin film. A natural oxide film may be formed, reducing the total capacitance of the capacitor. Furthermore, a reduction in capacitance can occur due to a depletion region formed in the polysilicon layer. For these reasons, the PIP capacitor is unsuitable for high-speed and high-frequency operations.

To solve this problem, an MIM capacitor, in which both the upper and lower electrodes are formed using a metal layer, was proposed. Currently, the MIM capacitor may be used in high-performance semiconductor devices because it exhibits a low specific resistance, and does not exhibit a parasitic capacitance caused by an internal depletion.

However, related MIM capacitors have a relatively low capacity for the effective area they use. It may be possible to increase the capacitor value by increasing the capacitor area or by using a film having a high dielectric constant.

The method of increasing the capacitor area undesirably increases chip area. Also, the use of a film having a high dielectric constant requires additional investment in equipment, or a new process. Furthermore, where a large, lower capacitor copper pattern is formed, a dishing phenomenon may occur during a chemical mechanical polishing (CMP) process for copper lines. That is, the copper lines may be recessed. In this case, it may be practically impossible to obtain an accurate capacitance value. This may cause a degradation in the characteristics of the analog device, including a reduction in the leakage and breakdown voltages. Consequently, reliability becomes a problem.

### SUMMARY

Embodiments relate to a semiconductor device and a method for manufacturing the same, and more particularly, to a metal-insulator-metal (MIM) capacitor capable of achieving an enhancement in the reliability of a semiconductor device and a method for manufacturing the same. Embodiments relate to a metal-insulator-metal (MIM) capacitor which may include a first insulating film, a first metal layer formed over the first insulating film and a first capacitor insulating film formed over the first metal layer. A second metal layer may be formed over a portion of the first capacitor insulating film and second capacitor insulating film may be formed over the second metal layer. A third metal layer may be formed over a portion of the second capacitor insulating film and a nitride film may be formed over the third metal layer. A multilayer insulating film may be formed over the entire upper surface of the resulting structure. First and second metal lines may be formed in contact holes extending through the first capacitor insulating film, the second capacitor insulating film, and the nitride film after extending through the multilayer insulating film.

Embodiments relate to a method for manufacturing a metal-insulator-metal capacitor which includes: sequentially forming a first capacitor insulating film, a second metal layer, a second capacitor insulating film, a third metal layer, and a nitride film over a first insulating film including a first metal layer; forming a multilayer insulating film over an entire upper surface of the resulting structure; etching the multilayer insulating film, the nitride film, the first capacitor insulating film, and the second capacitor insulating film, thereby forming contact holes; and depositing copper in the contact holes, and planarizing the deposited copper using a chemical mechanical polishing process, thereby forming first and second metal lines.

### DRAWINGS

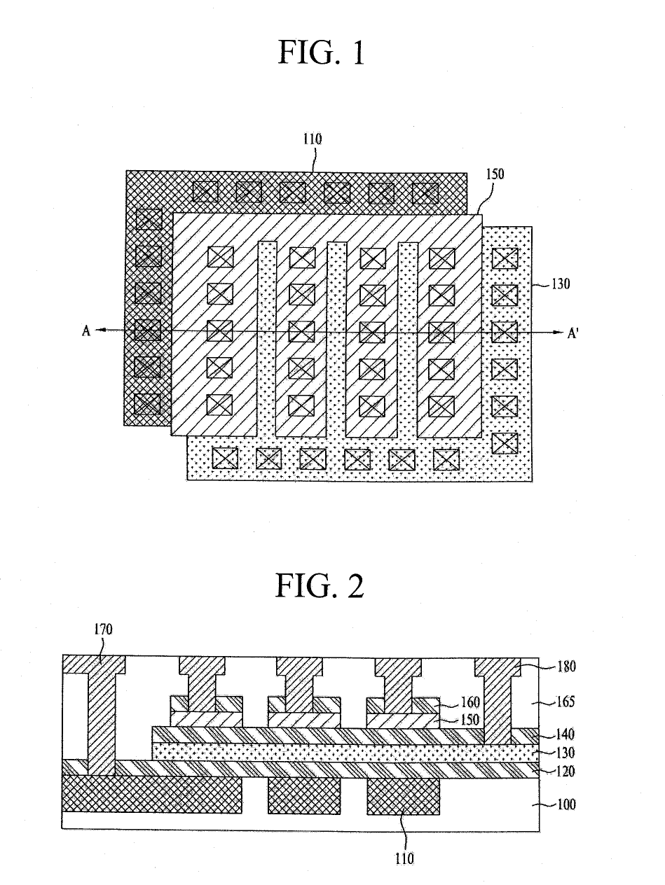

Example FIG. 1 is a plan view illustrating a MIM capacitor according to embodiments.

Example FIG. 2 is a cross-sectional view taken along the line A-A′ of example FIG. 1.

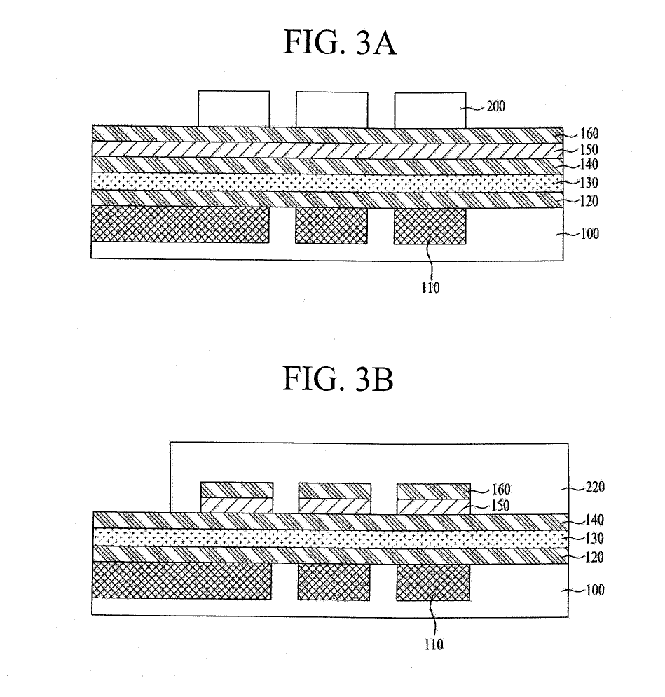

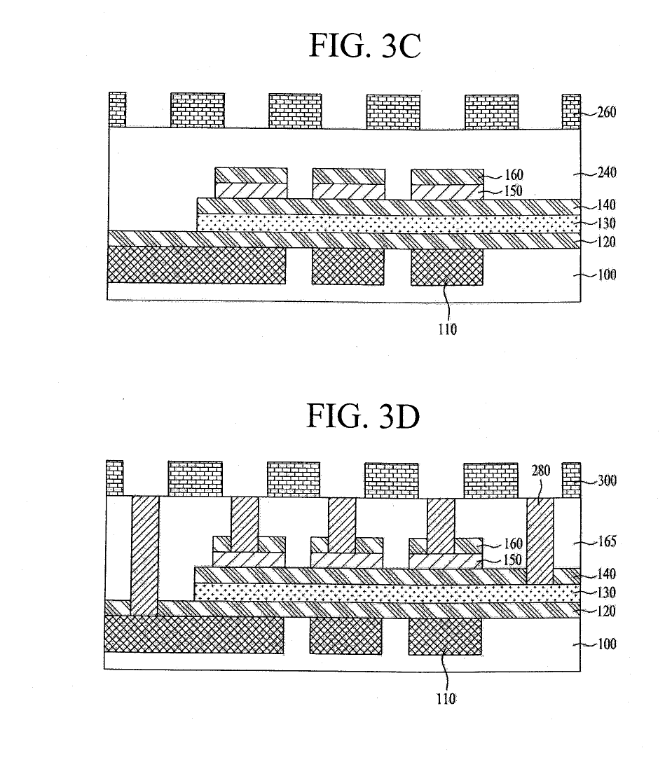

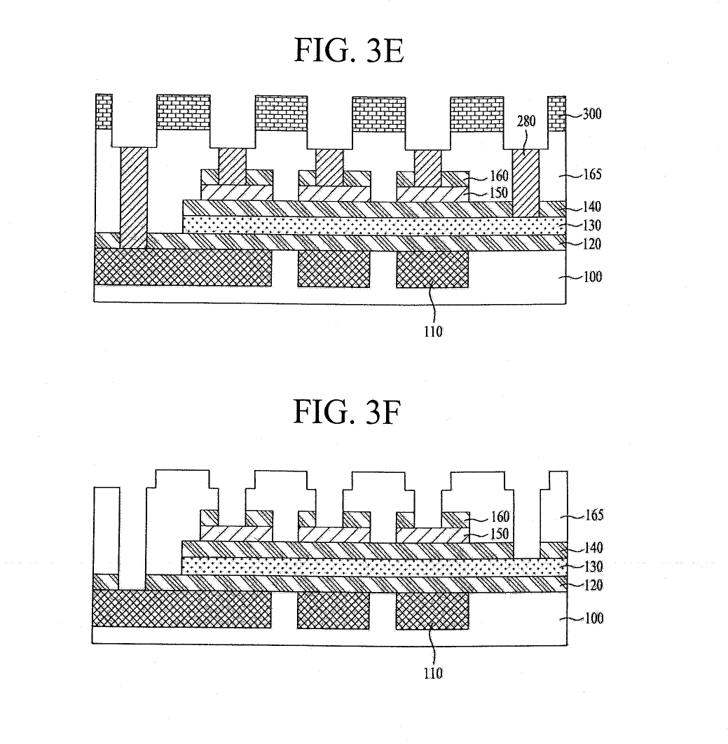

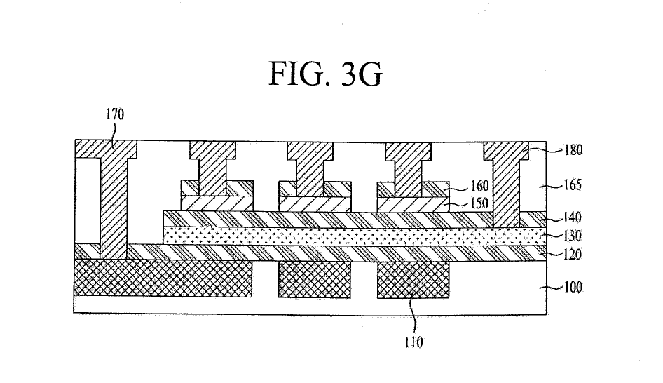

Example FIGS. 3A to 3G are sectional views illustrating a method for manufacturing the MIM capacitor shown in example FIG. 1.

### DESCRIPTION

Reference will now be made in detail to embodiments associated with a metal-insulator-metal (MIM) capacitor and a method for manufacturing the same, examples of which are illustrated in the accompanying drawings. Example FIG. 1 is a plan view illustrating an MIM capacitor according to embodiments. Example FIG. 2 is a cross-sectional view taken along the line A-A′ of example FIG. 1.

As shown in example FIGS. 1 and 2, the MIM capacitor according to embodiments may include a lower insulating film 100. A lower metal layer 110 may be formed over the lower insulating film 100. A first capacitor insulating film 120 may be formed over the lower metal layer 110, and a central metal layer 130 may be formed over a portion of the first capacitor insulating film 120. A second capacitor insulating film 140 may be formed over the central metal layer 130. The MIM capacitor may also include an upper metal layer 150 formed over a portion of the second capacitor insulating film 140, a nitride film 160 formed over the upper metal layer 150, and a multilayer insulating film 165 formed over the first capacitor insulating film 120 including the nitride film 160. The MIM capacitor may further include a first metal line 170 extending through the first capacitor insulating film 120 and multilayer insulating film 165, to connect the upper metal layer 150 and lower metal layer 110. A second metal line 180 extends through the second capacitor insulating film 140 and multilayer insulating film 165, to connect the lower metal layer 110 and central metal layer 130.

The lower metal layer 110 may be formed to have a slitted structure, using a metal such as copper. The slitted structure of the lower metal layer 110 separates various portions the lower metal layer 110. The slitted structure makes it possible to prevent a dishing phenomenon during a chemical mechanical polishing (CMP) process for the lower metal layer 110. Because the dishing phenomenon is prevented, a desired capacitance and breakdown voltage, with an acceptable leakage current, can be stably obtained. Thus, the reliability of the capacitor can be enhanced.

The central metal layer 130 may be formed over a desired portion of the first capacitor insulating film 120, using one of Ti, Ti/TiN, and Ti/Al/TiN. The upper metal layer 150 may be formed over the second capacitor insulating film 140 such that it has a slitted structure, using one of Ti, Ti/TiN, and Ti/Al/TiN. The first capacitor insulating film 120, second capacitor insulating film 140, and nitride film 160 may be made of the same material. The first capacitor insulating film 120 and second capacitor insulating film 140 may have a thickness of 450 to 700 Å.

The first copper line 170 may connect the upper and lower metal layers 150 and 110. The second copper line 180 may connect the lower and central metal layers 110 and 130. As the upper and lower metal layers 150 and 110 may be connected by the first copper line 170, they function as a top plate of the capacitor. As the lower and central metal layers 110 and 130 may be connected by the second copper line 180, they function as a bottom plate. Since the capacitor portion constituted by the upper and lower metal layers 150 and 110 connected by the first copper line 170 and the capacitor portion constituted by the lower and central metal layers 110 and 130 connected by the second copper line 180 may be connected in parallel, the total capacitor value may be increased.

In the configuration described above, the MIM capacitor achieves an increase in capacitor value, using the existing equipment and processes, without any additional equipment investment or any addition process setting. Since it is possible to secure an increased capacitor value for the existing capacitor area, the size of the semiconductor device can be minimized.

Hereinafter, a method for manufacturing a MIM capacitor having the configuration described above and in accordance with embodiments will be described. Example FIGS. 3A to 3G are sectional views illustrating a method for manufacturing the MIM capacitor in accordance with embodiments. As shown in example FIG. 3A, the lower metal layer 110 may be formed first, over the lower insulating film 100, using a patterning process. Thereafter, the first capacitor insulating film 120, central metal layer 130, second capacitor insulating film 140, upper metal layer 150, and nitride film 160 may be sequentially deposited over the lower metal layer 110. Subsequently, a first mask may be used to form a first mask pattern 200 over the nitride film 160 using an exposure and development process.

The lower metal layer 110 may be made of a metal such as copper. The central and upper metal layers 130 and 150 may be made using one of Ti, Ti/TiN, and Ti/Al/TiN. Each of the lower and upper metal layers 110 and 150 may be formed with a slitted structure. The first capacitor insulating film 120, second capacitor insulating film 140, and nitride film 160 may be made of the same material. The first and second capacitor insulating films 120 and 140 may have a thickness of 450 to 700 Å. The nitride film 160 may be thicker than the first and second capacitor insulating films 120 and 140.

As shown in example FIG. 3B, the nitride film 160 and upper metal layer 150 may be etched using the first mask pattern 200, using a dry etching process or a wet etching process, such that the second capacitor insulating film 140 may be partially exposed. The first mask pattern 200 may then be removed. Subsequently, a second mask may be used to form a second mask pattern 220 over the second capacitor insulating film 140 including the etched nitride film 160 and upper metal layer 150, using an exposure and development process.

As shown in example FIG. 3C, the central metal layer 130 and second capacitor insulating film 140 may be etched using the second mask pattern 220, using a wed or dry etching process, to partially expose the first capacitor insulating film 120. The second mask pattern 220 may then be removed. Subsequently, a multilayer insulating film 165 may be deposited over the first capacitor insulating film 120 including the etched nitride film 160 and upper metal layer 150. A third mask pattern 260 may be formed over the multilayer insulating film 165 using an exposure and development process with a third mask.

As shown in example FIG. 3D, the multilayer insulating film 165 may be etched using the third mask pattern 260 with a wet or dry etching process. This may expose the first capacitor insulating film 120, second capacitor insulating film 140 and nitride film 160. The third mask pattern 260 may then be removed. A sacrificial photoresist 280 may be coated over the etched portions of the multilayer insulating film 165, using a full-surface etching process. A fourth mask pattern 300 may then be formed over the multilayer insulating film 165 including the sacrificial photoresist 280, with an exposure and development process using a fourth mask.

As shown in example FIG. 3E, the multilayer insulating film 165 and sacrificial photoresist 280 may be partially etched in regions where the sacrificial photoresist 280 is coated using the fourth mask pattern 300 with a dry etching process. This process may be used to form grooves etched to a certain depth in the exposed portions of the multilayer insulating film 165.

As shown in example FIG. 3F, the remaining sacrificial photoresist 280 and fourth mask pattern 300 may then be removed using a photoresist stripping process to form contact holes. The lower metal layer 110, central metal layer 130, and upper metal layer 150 may be exposed through the contact holes.

As shown in example FIG. 3G, copper may be deposited in the contact holes. Deposited copper may be planarized with a CMP process, to form first and second copper lines 170 and 180.

As apparent from the above description, the MIM capacitor according to embodiments may have the following effects. First, it is possible to achieve an enhancement in capacitor value, using the existing equipment and process, without an additional equipment investment or an additional process setting. Second, it is possible to secure an increased capacitor value for the existing capacitor area, and thus to minimize the chip size. Third, it is possible to separate portions of the lower metal layer of the capacitor to prevent a dishing phenomenon during a CMP process. Fourth, desired values of capacitance, leakage current, and breakdown voltage can be stably obtained by preventing the dishing phenomenon. Thus, the reliability of the capacitor can be enhanced.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a first insulating film;
a first metal layer formed over the first insulating film;
a first capacitor insulating film formed over the first metal layer;
a second metal layer formed over a portion of the first capacitor insulating film;
a second capacitor insulating film formed over the second metal layer;
a third metal layer formed over a portion of the second capacitor insulating film;
a nitride film formed over the third metal layer;
a multilayer insulating film formed over the entire upper surface of the resulting structure; and
first and second metal lines formed in contact holes extending through the first capacitor insulating film, the second capacitor insulating film, and the nitride film after extending through the multilayer insulating film.

2. The apparatus of claim 1, wherein the first metal line connects the third and first metal layers.

3. The apparatus of claim 1, wherein the second metal line connects the first and second metal layers.

4. The apparatus of claim 1, wherein the first metal layer is formed using copper to have a slitted structure.

5. The apparatus of claim 1, wherein the second metal layer is made of one of Ti, Ti/N, and Ti/Al/TiN.

6. The apparatus of claim 1, wherein the third metal layer is formed, using one of Ti, Ti/N, and Ti/Al/TiN, to have a slitted structure.

7. The apparatus of claim 1, wherein the first capacitor insulating film, the second capacitor insulating film, and the nitride film are made of substantially the same material.

8. The apparatus of claim 1, wherein each of the first and second capacitor insulating films has a thickness of about 450 to 700 Å.

9. The apparatus of claim 1, wherein the third and first metal layers are connected by the first metal line, and the first and second metal layers are connected by the second metal line, to constitute capacitor portions connected in parallel.

10. A method comprising:
sequentially forming a first capacitor insulating film, a second metal layer, a second capacitor insulating film, a third metal layer, and a nitride film over a first insulating film including a first metal layer;
forming a multilayer insulating film over an entire upper surface of the resulting structure;
etching the multilayer insulating film, the nitride film, the first capacitor insulating film, and the second capacitor insulating film, thereby forming contact holes; and
depositing copper in the contact holes, and planarizing the deposited copper using a chemical mechanical polishing process, thereby forming first and second metal lines.

11. The method of claim 10, wherein forming the multilayer insulating film over the entire upper surface of the resulting structure comprises:
etching the nitride film and the third metal layer, using a first mask pattern, to expose the second capacitor insulating film; and
partially etching the second metal layer and the second capacitor insulating film, using a second mask pattern, to partially expose the first capacitor insulating film.

12. The method of claim 10, wherein each of the etched nitride film and the etched third metal layer has a slitted structure having slits spaced apart from one another by a predetermined distance.

13. The method of claim 10, wherein etching the multilayer insulating film, the nitride film, the first capacitor insulating film, and the second capacitor insulating film, thereby forming contact holes, comprises:
etching portions of the multilayer insulating film to partially expose the first capacitor insulating film, the nitride film, and the second capacitor insulating film, and forming a sacrificial photoresist in the etched portions of the multilayer insulating film;
partially etching the multilayer insulating film and the sacrificial photoresist in regions where the sacrificial photoresist is formed, thereby forming grooves having a predetermined depth in the multilayer insulating film;
removing the sacrificial photoresist; and
etching the multilayer insulating film, the nitride film, and the second capacitor insulating film to partially expose the first metal layer, the second metal layer, and the third metal layer.

14. The method of claim 10, wherein the first metal layer is formed using copper to have a slitted structure.

15. The method of claim 10, wherein each of the third metal layer and the second metal layer is formed using one of Ti, Ti/N, and Ti/Al/TiN.

16. The method of claim 10, wherein the first capacitor insulating film, the second capacitor insulating film, and the nitride film are made of substantially the same material.

17. The method of claim 10, wherein the first and second capacitor insulating films have substantially the same thickness.

18. The method of claim 10, wherein each of the first and second capacitor insulating films has a thickness of about 450 to 700 Å.

19. The method of claim 10, wherein the nitride film is substantially thicker than each of the first and second capacitor insulating films.

20. The method of claim 10, wherein the third and first metal layers are connected by the first metal line, and the first and second metal layers are connected by the second metal line, to constitute capacitor portions connected in parallel.
